SEQUENCE LISTING (5 sequences)

SEQ ID NO: 1 - protein, 842 aa, Mus musculus
MLFWAAHLLLSLQLAVAYCWAFSCQRTESSPGFSLPGDFLLAGLFSLHADCLQVRHRPLVTSCDRSDSFNGHGYHLFQAMRFTVEEINNSTALLPNITLGYELYDVCSESSNVYATLRVLAQQGTGHLEMQRDLRNHSSKVVALIGPDNTDHAVTTAALLSPFLMPLVSYEASSVILSGKRKFPSFLRTIPSDKYQVEVIVRLLQSFGWVWISLVGSYGDYGQLGVQALEELATPRGICVAFKDVVPLSAQAGDPRMQRMMLRLARARTTVVVVFSNRHLAGVFFRSVVLANLTGKVWIASEDWAISTYITNVPGIQGIGTVLGVAIQQRQVPGLKEFEESYVQAVMGAPRTCPEGSWCGTNQLCRECHAFTTWNMPELGAFSMSAAYNVYEAVYAVAHGLHQLLGCTSGTCARGPVYPWQLLQQIYKVNFLLHKKTVAFDDKGDPLGYYDIIAWDWNGPEWTFEVIGSASLSPVHLDINKTKIQWHGKNNQVPVSVCTRDCLEGHHRLVMGSHHCCFECMPCEAGTFLNTSELHTCQPCGTEEWAPEGSSACFSRTVEFLGWHEPISLVLLAANTLLLLLLIGTAGLFAWRLHTPVVRSAGGRLCFLMLGSLVAGSCSLYSFFGKPTVPACLLRQPLFSLGFAIFLSCLTIRSFQLVIIFKFSTKVPTFYHTWAQNHGAGIFVIVSSTVHLFLCLTWLAMWTPRPTREYQRFPHLVILECTEVNSVGFLVAFAHNILLSISTFVCSYLGKELPENYNEAKCVTFSLLLHFVSWIAFFTMSSIYQGSYLPAVNVLAGLATLSGGFSGYFLPKCYVILCRPELNNTEHFQASIQDYTRRCGTT

SEQ ID NO: 2 - protein, 840 aa, Rattus rattus
MLFWAAHLLLSLQLVYCWAFSCQRTESSPGFSLPGDFLLAGLFSLHGDCLQVRHRPLVTSCDRPDSFNGHGYHLFQAMRFTVEEINNSSALLPNITLGYELYDVCSESANVYATLRVLALQGPRHIEIQKDLRNHSSKVVAFIGPDNTDHAVTTAALLGPFLMPLVSYEASSVVLSAKRKFPSFLRTVPSDRHQVEVMVQLLQSFGWVWISLIGSYGDYGQLGVQALEELAVPRGICVAFKDIVPFSARVGDPRMQSMMQHLAQARTTVVVVFSNRHLARVFFRSVVLANLTGKVWVASEDWAISTYITSVTGIQGIGTVLGVAVQQRQVPGLKEFEESYVRAVTAAPSACPEGSWCSTNQLCRECHTFTTRNMPTLGAFSMSAAYRVYEAVYAVAHGLHQLLGCTSEICSRGPVYPWQLLQQIYKVNFLLHENTVAFDDNGDTLGYYDIIAWDWNGPEWTFEIIGSASLSPVHLDINKTKIQWHGKNNQVPVSVCTTDCLAGHHRVVVGSHHCCFECVPCEAGTFLNMSELHICQPCGTEEWAPKESTTCFPRTVEFLAWHEPISLVLIAANTLLLLLLVGTAGLFAWHFHTPVVRSAGGRLCFLMLGSLVAGSCSFYSFFGEPTVPACLLRQPLFSLGFAIFLSCLTIRSFQLVIIFKFSTKVPTFYRTWAQNHGAGLFVIVSSTVHLLICLTWLVMWTPRPTREYQRFPHLVILECTEVNSVGFLLAFTHNILLSISTFVCSYLGKELPENYNEAKCVTFSLLLNFVSWIAFFTMASIYQGSYLPAVNVLAGLTTLSGGFSGYFLPKCYVILCRPELNNTEHFQASIQDYTRRCGTT

SEQ ID NO: 3 - protein, 841 aa, Homo sapiens
MLLCTARLVGLQLLISCCWAFACHSTESSPDFTLPGDYLLAGLFPLHSGCLQVRHRPEVTLCDRSCSFNEHGYHLFQAMRLGVEEINNSTALLPNITLGYQLYDVCSDSANVYATLRVLSLPGQHHIELQGDLLHYSPTVLAVIGPDSTNRAATTAALLSPFLVPMISYAASSETLSVKRQYPSFLRTIPNDKYQVETMVLLLQKFGWTWISLVGSSDDYGQLGVQALENQATGQGICIAFKDIMPFSAQVGDERMQCLMRHLAQAGATVVVVFSSRQLARVFFESVVLTNLTGKVWVASEAWALSRHITGVPGIQRIGMVLGVAIQKRAVPGLKAFEEAYARADKKAPRPCHKGSWCSSNQLCRECQAFMAHTMPKLKAFSMSSAYNAYRAVYAVAHGLHQLLGCASGACSRGRVYPWQLLEQIHKVHFLLHKDTVAFNDNRDPLSSYNIIAWDWNGPKWTFTVLGSSTWSPVQLNINETKIQWHGKDNQVPKSVCSSDCLEGHQRVVTGFHHCCFECVPCGAGTFLNKSDLYRCQPCGKEEWAPEGSQTCFPRTVVFLALREHTSWVLLAANTLLLLLLLGTAGLFAWHLDTPVVRSAGGRLCFLMLGSLAAGSGSLYGFFGEPTRPACLLRQALFALGFTIFLSCLTVRSFQLIIIFKFSTKVPTFYHAWVQNHGAGLFVMISSAAQLLICLTWLVVWTPLPAREYQRFPHLVMLECTETNSLGFILAFLYNGLLSISAFACSYLGKDLPENYNEAKCVTFSLLFNFVSWIAFFTTASVYDGKYLPAANMMAGLSSLSSGFGGYFLPKCYVILCRPDLNSTEHFQASIQDYTRRCGST

SEQ ID NO: 4 - protein, 841 aa, Canis familiaris
MSLLAAHLVSLQLSLSCCWALSCHNTESSPDFSLPGDYLLAGLFPLHSDCPGVRRRPMVTLCDRPNSFNGHGYHLFQAMRFGIEEINNSTTLLPNVTLGYQLYDVCSESANVYATLNVLSTLGTHHIEIQADPSHYSPAALAVIGPDTTNHAATAAALLSPFLVPVISYEASSVMLGVKRYYPSFLRTIPSDKYQVEIMVLLLQRFGWVWISLVGSDGDYGQLGVQALEEQATQQGICIAFKDIIPFSAQPGNERMQSMMYHLDRARTTVVVVFSSRQLARVFFESVVLAKLTAKVWIASEDWAISRHISSLPRIWGIGTVLGVAIQQKLVPGLKEFEEAYVRAKKAAHRPCSRDSWCSSNQLCRECQAFTVQQMPTLGAFSMSSAYNAYRAVYAAAHGLHQLLGCASGACSRDRVYPWQLLEQIRKVNFLLHEDTVIFNDNGDPLSGYDIIAWDWSGPKWTFRVIGSSTWPPVQLDINKTKIRWHGEDNQVPESVCSSNCLEGHQRVVVGFYHCCFECVPCEAGTFLNKSDLHSCQPCGKEEWAPEGSESCFLRTVVFLTWHEPISWVLLAANTLLLLLVAGTAGLFAWHLDTPVVRSAGGRLCFFMLGSLAGGSCGLYGFFGEPTLATCLLRQGLFALGFAIFLSCLTIRSFQLVFIFKFSAKVPTFYQAWVQNHGPRLFVVISSMAQLLICVTWLAVWTPLPTREYQRFPQLVVLDCTEANSPGFMVAFAYNGLLSVSAFACSYLGKDLPENYNEAKCVTFSLLLNFVSWIGFFTTASVYQGKYLPAVNVLAALSSLSSGFSGYFLPKCYVILCRPDLNSTEHFQASIQDYTRRCGST

SEQ ID NO: 5 - protein, 718 aa, Felis catus
  misc_feature (64)..(166): Xaa can be any naturally occurring amino acid
MSLPAAHLVGLQLSLSCCWALSCHSTETSADFSLPGDYLLAGLFPLHSDCPGVRHRPTVTLCDXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXXISYEASSVTLGVKRHYPSFLRTIPSDKHQVEAMVLLLQSFGWVWISVVGSDGDYGQLGVQALEEQATQQGICVAFKDIIPFSARPGDERMQGIMHHLARARTTVVVVFSSRQLARVFFESVVLANLTAKVWIASEDWAISRHISNVPGIQGIGTVLGVAIQQRLVPGLKEFEEAYVQADKGAPGPCSRTSECSSNQLCRECRAFTAEQMPTLGAFSMSSAYNAYRAVYAVAHGLHQLLGCASGACSRDRVYPWQLLEQIRKVNFLLHKDTVRFNDNGDPLSGYDIIAWDWSGPKWNFRVIGSSMWPPVQLDINKTKIRWHGKDNQVPKSVCSSDCLEGHQRVISGFYHCCFECVPCEAGSFLNKSDLHSCQPCGKEEWAPAGSETCFPRTVVFLTWHETISWVLLAANTLLLLLVTGTAGLFAWHLDTPVVKSAGGRLCFFMLGSLAGGSCGLYGFFGEPTLPTCLLRQSLLALGFAIFLSCLTIRSFQLVFIFKFSAKVPTFYRAWVQNHGPGLFVVISSMAQLLICLTWLAVWTPLPTREYQRFPQLVVL

(19) United States
(12) Patent Application Publication
(10) Pub. No.: US 2015/0257412 A1
(43) Pub. Date: Sep. 17, 2015

(54) FLAVOUR ADDITIVES

(71) Applicants: Scott MCGRANE, (US); Andrew TAYLOR, (US); MARS, INCORPORATED, Mclean, VA (US)

(72) Inventors: Scott McGrane, Melton Mowbray Leicestershire (GB); Andrew Taylor, Melton Mowbray Leicestershire (GB)

(21) Appl. No.: 14/438,834

(22) PCT Filed: Oct. 31, 2013
(86) PCT No.: PCT/EP2013/072788

§ 371 Date: Apr. 27, 2015

(30) Foreign Application Priority Data
Oct. 31, 2012 (EP) 12190902.2

(51) Int. Cl. A23K 1/16; A23K 1/18

(52) U.S. Cl. CPC A23K 1/1621; A23K 1/1846; A23K 1/1634

(57) ABSTRACT

The present invention relates to the use of a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones for increasing the palatability of a foodstuff to a companion animal. The invention also relates to a pet foodstuff or supplement comprising a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones, and also to a method of increasing the palatability of a foodstuff to a companion animal.

The present invention relates to the use of a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones for increasing the palatability of a foodstuff to a companion animal. The invention also relates to a pet foodstuff or supplement comprising a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones, and also to a method of increasing the palatability of a foodstuff to a companion animal.

It is well known that many feline and canine companion animals are fussy with their food. An animal will often refuse to eat a foodstuff that it has been accepting over some time, or refuse to eat any more than a minimal amount of a foodstuff. Part of this phenomenon can be driven by subtle changes in the sensory profile of the raw materials. These changes might not be perceived by the human consumer, but due to a difference in the olfactory and gustatory systems, feline and canine companion animals may well perceive these differences. These sensory differences can be due to natural variation of the raw materials used or when materials are in short supply and have to be substituted with alternatives. This can be very frustrating for the owner and can result in the owner perceiving that the animal is unhappy and not enjoying its food. An animal may also fail to ingest its required amount of essential nutrients if not consuming an adequate amount of food available to it. Therefore, it can clearly be seen that there exists a need for a way to encourage companion animals to eat the foodstuff with which it is provided. Many solutions have been suggested to overcome this problem. Most commercially available pet foods are provided in a range of different flavours and/or textures. However, the companion animal owner will know that often a companion animal will suddenly, for no clear reason, refuse the flavour that the owner perceives to be its most preferred. Much research has been carried out on the flavour preferences of companion animals, by offering them a choice of different foodstuffs. The present inventors have taken this research further by studying the key taste receptor in cat, the umami receptor (umami flavour is also referred to as savoury or meat flavour and identifying the associated taste mechanisms. They have looked at a range of compounds, volatile and non-volatile, that are found in naturally occurring foodstuffs and established the interactions of these compounds and therefore developed a combination for optimal taste. Of particular interest and importance has been a focus on compounds that interact with and are perceived via the umami receptor.

Surprisingly, the inventors have found that companion animals show a strong and consistent preference for certain combinations of compounds, whether presented to the animals in water, a gel or in a model foodstuff. The present invention therefore relates to a use of a combination of compounds that is highly desirable to a companion animal for increasing palatability of a foodstuff to a companion animal. The companion animal is preferably a mammalian companion animal.

When a companion animal eats its recommended amount of (main meal) foodstuff each day, the animal will receive its required level of vitamins and minerals, and thus is highly likely to remain healthy and happy. Furthermore, the owner is satisfied that the animal is eating well. The inventors have identified certain volatile and non-volatile compounds that are present in natural products that particularly appeal to companion animals in combination. Non-volatile compounds relate to taste, (i.e. they are detected on the tongue); volatile compounds relate to aroma, and are compounds that affect the smell of the food, (i.e. compounds detected in the nose); and some compounds fall within both categories. The combination of both taste and aroma give the food its flavour. Flavour, as used herein, therefore encompasses both the taste and aroma of a foodstuff.

The invention, therefore, provides as a first aspect the use of a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones for increasing the palatability of a foodstuff to a companion animal and, therefore, for use in ensuring an adequate intake of food stuff by a companion animal.

The first amino acid is selected from the group consisting of glycine, asparagine, alanine, cysteine, histidine, leucine, methionine, phenylalanine, serine, tryptophan and tyrosine or a mixture of 2, 3, 4, 5, 6, 7, 8, 9, 10 or 11 thereof. The amino acid is preferably in the L-amino acid form.

The second amino acid is selected from the group consisting of aspartic acid, cystine, glutamic acid, glutamine, isoleucine, lysine, aspartic acid, ornithine, threonine, valine, proline and hydroxyproline or a mixture of 2, 3, 4, 5, 6, 7, 8, 9, 10, 11 or 12 thereof. The amino acid is preferably in the L-amino acid form.

The furanone is suitably as set out in formula I or formula II, below, optionally substituted by hydroxyl, C₁₋₆ alkyl, C₁₋₆ alkoxy.

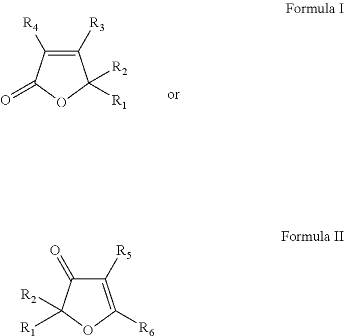

Each R₁ and R₂ are independently selected from hydrogen or C₁₋₆ alkyl, preferably hydrogen, methyl or ethyl;

R₃ is hydrogen, hydroxyl or C₁₋₆ alkyl, preferably methyl;
R₄ is hydrogen, hydroxyl or C₁₋₆ alkyl, preferably hydroxyl;
R₅ is hydrogen, hydroxyl, C₁₋₆ alkyl, C₁₋₆ alkoxy, 5 or 6 membered saturated heterocycle or —OC(O)R₇, preferably hydroxyl, —OCH₃, —OCH₂CH₃, —OC(O)CH₃, methyl or pyrrolidine;
R₆ is hydrogen or C₁₋₆ alkyl, preferably hydrogen or methyl;
R₇ is C₁₋₆ alkyl, preferably methyl.

The furanone may be selected from the group consisting of the furanones set out in Table 1, or a mixture of 2, 3, 4, 5, 6, 7, 8, 9, 10, 11 or 12 thereof. Suitably, the furanone is furaneol, homofuraneol, sotolon, norfuraneol, abhexon, mesifuranone, dimethoxyfuranone, or norfuraneol, as defined in Table 1. Alternatively, the furanone may be selected from the group consisting of furaneol, sotolon and abhexon, as defined herein in Table 1. Sotolon may also be referred to as sotolone.

TABLE 1

| Key Furanones | Additional Furanones |
|---|---|
| 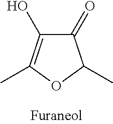 | 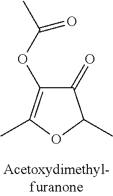 |
| 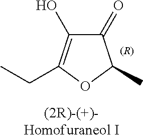 | 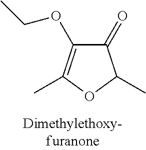 |
| 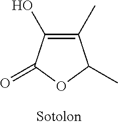 | 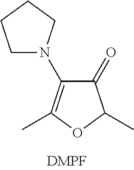 |
| 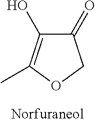 | 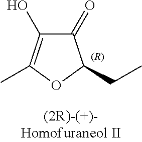 |
| 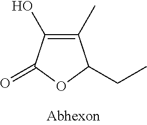 | 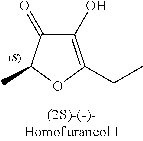 |
| 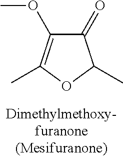 | 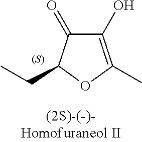 |

Optionally, the invention may also include the use of a pyrophosphate, such as tetra potassium pyrophosphate or a disodium pyrophosphate. Polyphosphates may be included in the composition also, such as sodium tripolyphosphate. The pyrophosphates and/or polyphosphates may be present in the composition at a concentration of 1 mM or above. Suitably, the concentration of pyrophosphate and/or polyphosphate may be 5 mM, 10 mM, 15 mM, 20 mM, 25 mM, 30 mM, 40 mM, 50 mM, 100 mM or 500 mM.

The invention includes a composition comprising a first amino acid, a second amino acid and one or more furanones, as herein defined, for use in increasing the palatability of a foodstuff to a companion animal. The composition may also comprise a pyrophosphate and/or polyphosphate as herein defined.

The first amino acid selected from the group consisting of glycine, alanine, cysteine, histidine, leucine, methionine, phenylalanine, serine, tryptophan and tyrosine or a mixture of two or more thereof; and a second amino acid selected from the group consisting of aspartic acid, cystine, glutamic acid, glutamine, isoleucine, lysine, aspartic acid, ornithine, threonine, valine, proline and hydroxyproline or a mixture of two or more thereof may be present (individually or as a combination) in an amount of less than 1M, 1 mM to 1M, 250 mM to 1M, 5 mM to 500 mM, 10 mM to 100 mM, 10 mM to 50 mM or 20 mM to 50 mM. The amount of amino acid may be less than 200 mM, less than 100 mM, less than 20 mM or less than 10 mM. The amino acid(s) may be present in an amount of 25 mM, 50 mM or 60 mM.

The one or more furanones may be present (individually or as a combination) at a concentration of greater than 0.005 ppm, 0.001 ppm to 40 ppm, 0.005 ppm to 20 ppm, 0.001 ppm to 5 ppm, 1 ppm to 10 ppm or 2 ppm to 5 ppm. The furanone(s) may be present in an amount less than 40 ppm. The furanone(s) may be present in an amount of 4 ppm.

The amino acids and the one or more furanones for use in the invention are in addition to those found naturally in meat, vegetable or dairy products that may form part of a food stuff. The amino acid(s) and furanone(s) may be added to a pet food during or after manufacture. The amino acid(s) and furanone(s) are added in order to enhance or optimise the flavour profile of the basic meat (or other macronutrient) ingredients of the pet food.

The companion animal is preferably a feline animal (cat), or a canine animal (dog) although it may also be a guinea pig, a rabbit, bird or a horse.

The invention also provides as a second aspect a pet foodstuff comprising a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof, and one or more furanones. The foodstuff may be packaged, wherein the packaging carries written or graphic information indicating that the pet foodstuff is meant to be consumed by a cat or a dog, or a guinea pig, a rabbit, a bird or a horse. The suitable and preferred features of the first aspect also apply to the second aspect, mutatis mutandis.

It should be noted that taurine is not included as an amino acid in respect of the invention. In fact, taurine is an organic sulfonic acid and lacks the carboxyl group which is characteristic of amino acids i.e. there is no COOH group. However in the art, such as described in US 2006/0286276 and US 2006/286275, taurine is often described as an amino acid, which is incorrect. Additionally, since taurine does not contain a carboxyl group it is postulated that it does not fit in the same way into the binding site of the umami receptor as does a first amino acid as defined by the invention.

The invention also relates to, as a third aspect, a composition comprising a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones for use in increasing the acceptance and/or ensuring adequate intake of a foodstuff in a companion animal. Increasing the palatability leads to increased enjoyment and acceptance of the foodstuff to the animal. Increased acceptance and enjoyment helps to overcome the fussiness of a companion animal with regard to food. Since the animal accepts and enjoys the foodstuff in accordance with the invention, it is more likely to reach its required daily calorie and nutrient intake.

The composition may be for use in increasing the appetising appeal of a foodstuff to an animal in order to encourage an animal to eat a healthy amount of foodstuff. Thus, the use of a composition comprising a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones in increasing the appetising appeal of a foodstuff; in encouraging a healthy intake of a foodstuff; in ensuring the required intake of nutrients and calories in a companion animal, is included in the present invention. By healthy level it is meant an amount that enables the animal to maintain or achieve an intake contributing to its overall general health in terms of micronutrients, macronutrients and calories. By this it is meant that an animal may eat sufficient calories and receive a nutritionally complete diet without needing to eat excess calories and thus maintaining a healthy balance, such as set out in the “Mars Petcare Essential Nutrient Standards”.

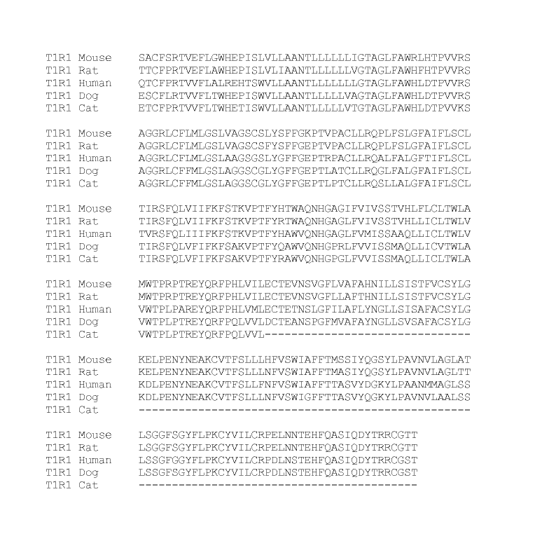

As mentioned above, the umami receptor has been studied as a target for flavour compounds. Many studies relating to the activation of the umami receptor focus on the human umami receptor. However, surprisingly the inventors have found that the umami receptor of humans differs in sequence to that of certain companion animals as shown in FIG. 13. Moreover, even though certain companion animals have shown preferences according to the art to particular amino acids, these preferences differ from animal to animal. Therefore, it is not possible to predict from work carried out in humans whether a companion animal would have the same response to the same amino acids.

In the human umami receptor, the key active site residues involved in glutamate and IMP binding have been identified by in silico modelling and by site-directed mutagenesis. These studies show that the key residues are at positions H71, T149, S172, D192, Y220, E301 S306 and S385 and the residues are highly conserved in other species. A comparison of the human, pig, mouse and cat sequences showed only two changes in these particular residues (pig L220 and mouse A385).

The high level of conservation in these active site residues does not fit well with the different amino acid specificity for the umami receptor in the species studied. A study on pig umami receptors identified other residues in the active site that were reported as being important in binding. The amino acids in these locations were conserved between humans and pigs (R277, R307 and H308). On the basis of this similarity, pig umami was proposed as a model for human umami. However, the pig umami receptor showed a wide amino acid specificity (glutamate, alanine, asparagine, glutamine, serine and threonine) compared to the usual glutamate and aspartate ligands that are associated with human umami receptor activation. A report that used some other amino acids (glycine, alanine, serine) at high concentrations (up to 1M) suggested that these compounds delivered a umami sensation in humans but the effect was only monitored using sensory analysis and no receptor studies were reported. Thus it seems that the range of amino acids that activate the human umami receptor are very limited compared to other species and that the residues identified so far do not satisfactorily explain the difference in amino acid specificity between the pig and human umami receptors.

The invention also provides a method of enhancing the umami flavour/taste of a foodstuff, the method comprising adding to or including in the foodstuff a first amino acid selected from the group consisting of glycine, alanine, cysteine, histidine, leucine, methionine, phenylalanine, serine, tryptophan and tyrosine or a mixture of two or more thereof; and a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones.

By enhancing it is meant that the umami flavour is detected more strongly/more intensely by the animal. The addition of a furanone synergistically increases the umami flavour potency.

The present invention also provides a method of increasing an animal's preference for a foodstuff, the method comprising the addition of a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and a furanone to the foodstuff. Also provided is a method of enhancing the umami flavour of a foodstuff, the method comprising the addition of a nucleotide, a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and a furanone to the foodstuff. A method of increasing the meaty (savoury) flavour of a foodstuff is also achieved by the use of a first amino acid selected from the group consisting of glycine, alanine, cysteine, histidine, leucine, methionine, phenylalanine, serine, tryptophan and tyrosine or a mixture of two or more thereof a second amino acid selected from the group consisting of aspartic acid, cystine, glutamic acid, glutamine, isoleucine, lysine, aspartic acid, ornithine, threonine, valine, proline and hydroxyproline and a furanone as described herein. The combination of the three components enables them to work in synergy to enhance umami flavour perception.

As a further aspect, the invention relates to a process for producing a pet foodstuff comprising a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones, the method comprising the steps of adding and mixing a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones with a pet foodstuff. The addition and/or mixing may be carried out prior to, during or after formulating, processing or packaging the foodstuff. The addition and/or mixing of the first amino acid, the second amino acid and furanone may be sequential or simultaneous.

All features of all aspects apply to all other aspects, mutatis mutandis.

The inventors have found that the addition of a first amino acid selected from the group consisting of glycine, alanine, cysteine, histidine, leucine, methionine, phenylalanine, serine, tryptophan and tyrosine or a mixture of two or more thereof a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones to a pet food product significantly increases the preference of a companion animal for the foodstuff. The animals show a strong preference for a foodstuff or water comprising a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof and one or more furanones over a foodstuff or water having none, or one or two of these compounds. This overcomes the difficulties associated with fussy animals and ensures an animal eats the entirety of the recommended daily amount of foodstuff provided to it, resulting in the health and wellbeing of the animal as well as the peace of mind of the owner.

The advantage, therefore, of a three component mixture for inclusion in a foodstuff is several-fold: an animal will be encouraged to eat the foodstuff on a consistent and long term basis; the synergistic effect means that a lower amount of each of the ingredients needs to be included in a foodstuff, meaning cost effective use of each of the amino acids and furanone.

Without wishing to be bound by theory, the present inventors believe that the umami taste receptor on the tongue of an animal can detect a first amino acid (importantly, selected from the group consisting of glycine, alanine, cysteine, histidine, leucine, methionine, phenylalanine, serine, tryptophan and tyrosine) and an alternative receptor or receptor detects the second amino acid (selected from the group consisting of aspartic acid, cystine, glutamic acid, glutamine, isoleucine, lysine, aspartic acid, ornithine, threonine, valine, proline and hydroxyproline) and thus, the effect of combining such a first amino acid and a second amino acid in the composition provides more than an additive effect of each component individually to the animal. This effect is further amplified by the addition of a furanone. The umami receptor is a heterodimeric transmembrane protein receptor and is also referred to in the art as T1R1/T1R3.

The present application shows that through in silico modelling of a non-human umami receptor and in vitro assays using a non-human umami receptor the inventors have found that the first amino acids of the present invention, (namely glycine, asparagine, alanine, cysteine, histidine, leucine, methionine, phenylalanine, serine, tryptophan and tyrosine) are each able to bind to and activate the umami receptor to different extents. The same in vitro assay demonstrated that the amino acids from the second group do not activate the umami receptor, and therefore are likely to bind and activate one or more different receptors. The positive acceptance of amino acids of the second group (aspartic acid, cystine, glutamic acid, glutamine, isoleucine, lysine, aspartic acid, ornithine, threonine, valine, proline and hydroxyproline), shown in in vivo tests confirm that these amino acids exert a flavour effect.

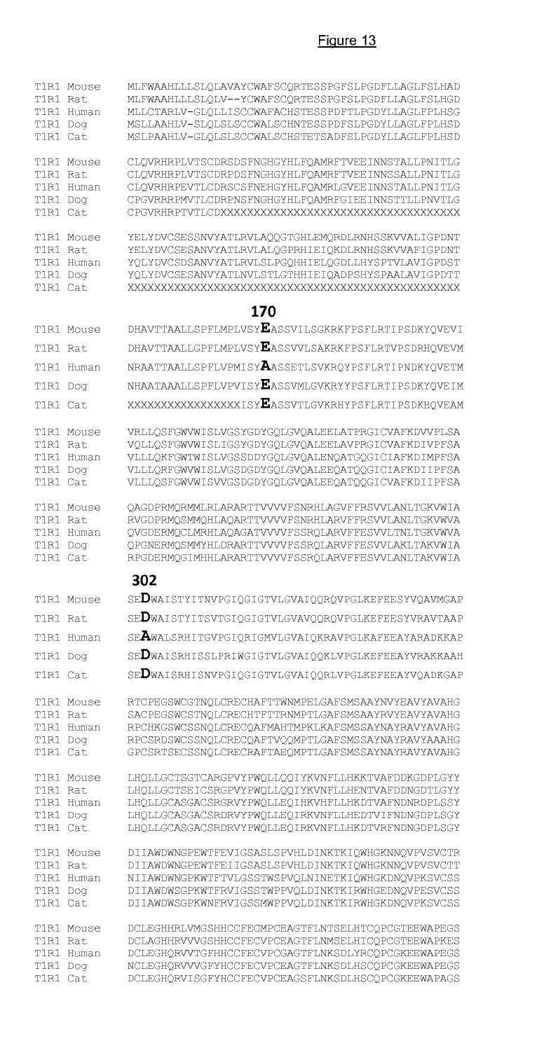

Further modelling of the cat umami receptor identified two other positions in the active site (170 and 302) that contained very different residues between human and other species and could potentially modify the access of amino acids of group one to the binding site and also modify the binding behaviour of such amino acids. It appears that the binding of one of the first amino acids of the invention may change the conformation of the umami receptor. As can be seen in FIG. 12, the receptor could be described in terms of a Venus Fly Trap, wherein the binding site consists of a structure similar to ‘jaws’, which close upon being bound by the compounds according to the invention. Once the amino acid of group one has bound within the “jaws” of the receptor, the receptor may be more amenable to the binding of other flavour components. It can be said that the amino acid potentially optimises the molecular environment for receptor binding of other molecules. It is hypothesised that amino acid ligands have a primary binding site in the T1R1 active site but they also make interactions with other residues around the active site. The nature and extent of the interactions depends on the functional groups present in the amino acid side chain e.g. carboxyl, amino or hydrophobic groups. Thus changes in other residues in the active site are postulated as a possible reason for the different amino acid binding specificities observed between species. Furthermore, it is postulated that once the amino acid of group one has bound, the furanone interacts synergistically to increase the umami flavour perception. This interaction may occur by cross talk between binding sites or during the transduction and neural processes.

The flytrap domain consists of two lobes, an upper lobe and a lower lobe that are connected by a region known as the hinge, (FIG. 12). The flytrap transitions from an open confirmation to a closed conformation upon binding of an amino acid of group one.

Further in vitro testing by the inventors has shown that the amino acids of the second group do not activate the umami receptor, as mentioned above.

Thus, the amino acids (selected from those listed herein) appear to work together in a coordinated manner increasing the perception of both compounds by the animal on one or more taste receptors when they are delivered together in a composition. Again, without wishing to be bound by theory, it appears that a first amino acid selected from the group consisting of glycine, alanine, cysteine, histidine, leucine, methionine, phenylalanine, serine, tryptophan and tyrosine or a mixture of two or more thereof; and a second amino acid selected from the group consisting of aspartic acid, cystine, glutamic acid, glutamine, isoleucine, lysine, aspartic acid, ornithine, threonine, valine, proline and hydroxyproline or a mixture of two or more thereof, complement each other by binding to different binding sites/receptors. The umami flavour perception created from the amino acids binding is further increased by the presence of a furanone, which acts in a synergistic manner.

The first amino acid selected from the group consisting of glycine, alanine, cysteine, histidine, leucine, methionine, phenylalanine, serine, tryptophan and tyrosine all have in common an uncharged side chain, and it should be noted that this list does not include cyclic amino acids, spyro amino acids or alpha disubstituted amino acids. Furthermore, the types of amino acids that bind to the umami receptor to increase the perception of such compounds by an animal may include aromatic, polar, lipophilic or small saturated ring amino acids.

As mentioned above, in addition to in silico modelling of the feline umami receptor, sequence alignments of the human, cat and dog receptors have been performed. Interestingly, the human sequence alignment shows that two amino acids at position 170 and 302 (numbered in relation to the human T1R1 receptor) are found as alanine residues in human, whereas these positions are glutamate and aspartate in the other species. Additionally, the feline umami receptor does not bind aspartate or glutamate, which are natural ligands for the human T1R1/T1R3 receptor. Therefore, due to these significant differences, it would not be expected by the skilled person that compounds that are known to bind to the human receptor would affect the umami receptor of other animals as described herein.

It is noted that Yoshi et al., (Synergistic Effects of 5′-Nucleotides on Rat Taste Responses to Various Amino Acids, Brain Research, 367 (1986) 45-51), conclude that a synergistic effect is seen between the amino acids and nucleotides. However, the experiments described were not carried out in vivo, but rather utilised in vitro nerve signalling. Notably, it was assumed that a nerve response was concluded to be a positive response. However, as it is well known in the art, a nerve response can also be a negative response for an animal i.e. in vivo a nerve response could be a negative taste perception. Further, it can be seen that the amino acids discovered to be most responsive are not those that correlate to the information provided by the present invention. This is almost certainly due to the ‘artificial’ environment in which the amino acids were tested by Yoshi et al.,

U.S. Pat. No. 3,524,747 describes the addition of a minimum of seven amino acids to a foodstuff to impart a “meaty” flavour. However, although a combination of seven amino acids could be contemplated by the present invention, the knowledge obtained by the inventors (that certain amino acids and a furanone achieve increased palatability) enables fewer than seven amino acids to be utilised to increase the palatability of a foodstuff.

It is notable that none of the prior art known to the inventors contemplates the use of at least two amino acids, (particularly, a first amino acid selected from the group consisting of glycine, alanine, cysteine, histidine, leucine, methionine, phenylalanine, serine, tryptophan and tyrosine or a mixture of two or more thereof; and a second amino acid selected from the group consisting of aspartic acid, cystine, glutamic acid, glutamine, isoleucine, lysine, aspartic acid, ornithine, threonine, valine, proline and hydroxyproline or a mixture of two or more thereof) together with a furanone for enhancing the flavour of a foodstuff for a companion animal. As mentioned, the amino acids are thought to work in a synergistic way; the first amino acids binding to the umami receptor whereas the second amino acids do not appear to bind to the umami receptor, but having a mechanism of action through a different receptor or receptors.

The amino acids and furanone according to the present invention may be incorporated into any product which an animal, such as a dog or a cat, may consume in its diet. Thus, the invention covers standard food products, supplements, pet food, drinks, snacks and treats. The food product is preferably a cooked product. It may incorporate meat or animal derived material (such as beef, chicken, turkey, lamb, blood plasma, marrowbone etc. or two or more thereof). The food stuff alternatively may be meat free (preferably including a meat substitute such as soya, maize gluten or a soya product) in order to provide a protein source. The product may contain additional protein sources such as soya protein concentrate, milk proteins, gluten etc. The product may also contain a starch source, such as gelatinised starch, such as one or more grains (e.g. wheat, corn, rice, oats, barely etc) or may be starch free. A typical dry commercial cat and dog food contains about 10-70% crude protein, about 10-60% fat and the remainder being carbohydrate, including dietary fibre and ash. A typical wet, or moist product contains (on a dry matter basis) about 40% fat, 50% protein and the remainder being fibre and ash. The present invention is particularly relevant for a pet foodstuff as herein described which is sold as a diet, foodstuff or supplement for a cat or dog. In the present text the terms “domestic” dog and “domestic” cat mean dogs and cats, in particular Felis domesticus and Canis domesticus. Preferably, the pet foodstuff will meet the macronutrient requirements of an animal preferably a ratio of protein:fat:carbohydrate of approximately 50:40:10 for feline animals and 30:60:10 for a canine animal.

As can be seen from the examples, below, it has been surprisingly found that a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof, and a furanone of the invention provide a greater than additive effect when presented to an animal. In other words, the preference of a companion animal for the combination of a first amino acid selected from the group consisting of glycine, alanine, cysteine, histidine, leucine, methionine, phenylalanine, serine, tryptophan and tyrosine or a mixture of two or more thereof; a second amino acid selected from the group consisting of aspartic acid, cystine, glutamic acid, glutamine, isoleucine, lysine, aspartic acid, ornithine, threonine, valine, proline and hydroxyproline or a mixture of two or more thereof is greater than an additive effect of the preference for any or each of the individual compounds. The addition of a furanone increases this preference to a greater extent. That is, inclusion of a furanone increases preference by more than the additive effect of the preference for the furanone alone.

Thus, the unexpected benefit of the combination of the amino acids and one or more furanones is increased palatability. Without wishing to be bound by theory, the present inventors believe that this is due to the conformation and positioning of the binding site of the umami receptor for a first amino acid, the alternative receptor(s) for a second amino acid and the enhancing effect of furanone, as described above.

The invention will now be described in reference to the following Figures and Examples in which:

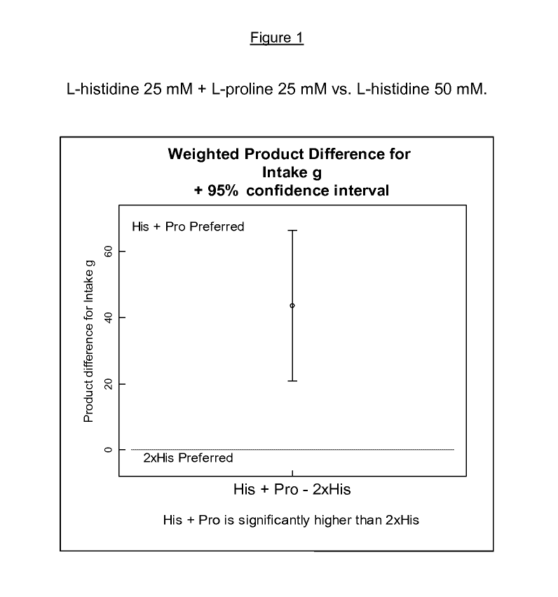

FIG. 1 shows the results in a difference test of a composition comprising 25 mM proline+25 mM histidine with a composition comprising 50 mM histidine only;

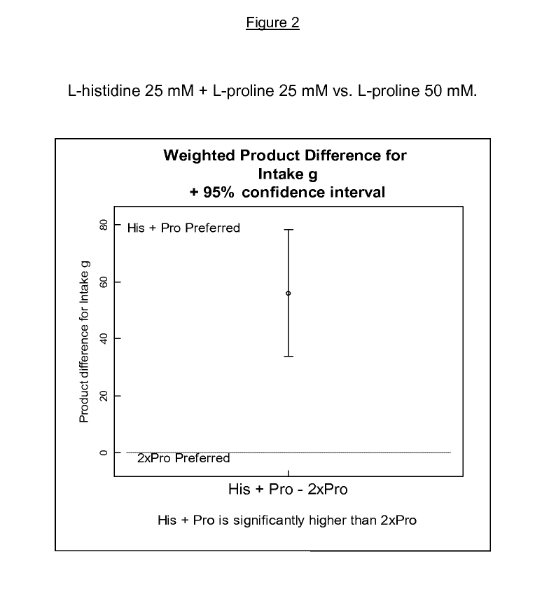

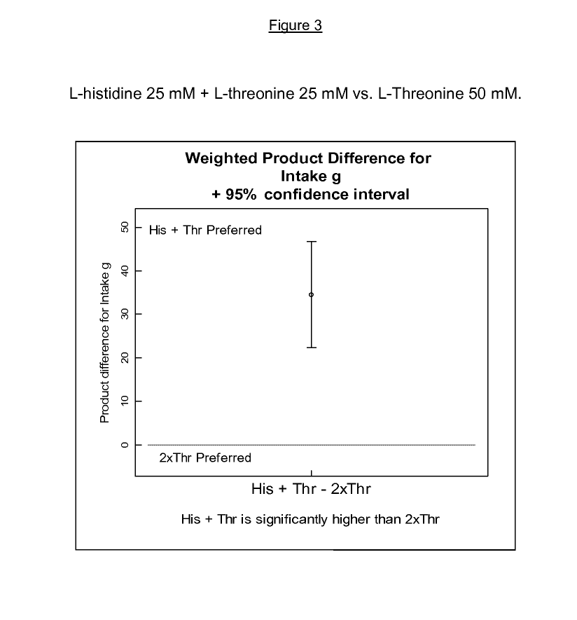

FIG. 2 shows the results in a difference test of a composition comprising 25 mM proline+25 mM histidine with a composition comprising 50 mM proline only;

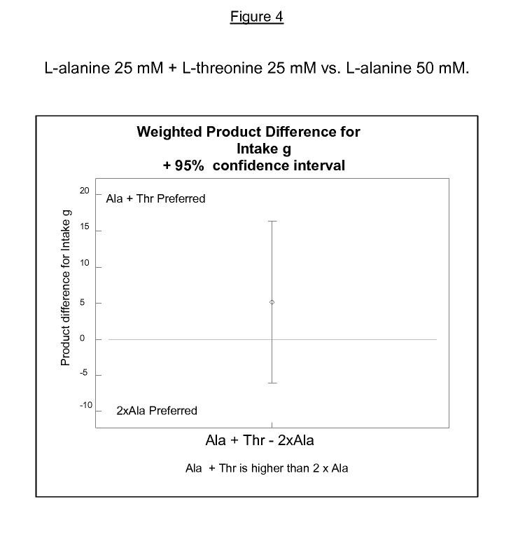

FIG. 3 shows the results in a difference test of a composition comprising 25 mM threonine+25 mM histidine with a composition comprising 50 mM threonine only;

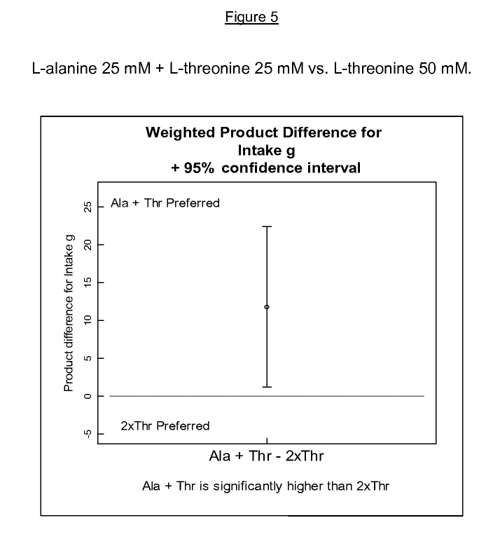

FIG. 4 shows the results in a difference test of a composition comprising 25 mM alanine+25 mM threonine with a composition comprising 50 mM alanine only.

FIG. 5 shows the results in a difference test of a composition comprising 25 mM alanine+25 mM threonine with a composition comprising 50 mM threonine only;

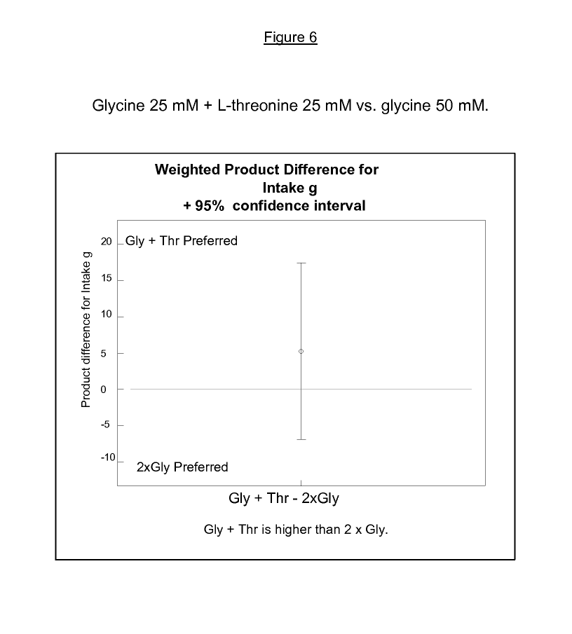

FIG. 6 shows the results in a difference test of a composition comprising 25 mM glycine+25 mM threonine with a composition comprising 50 mM glycine only;

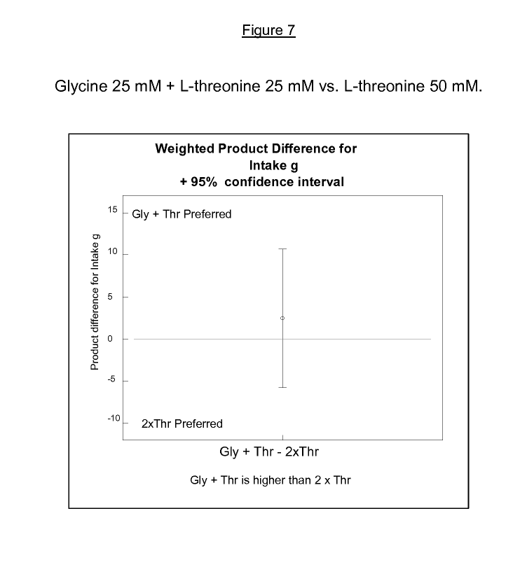

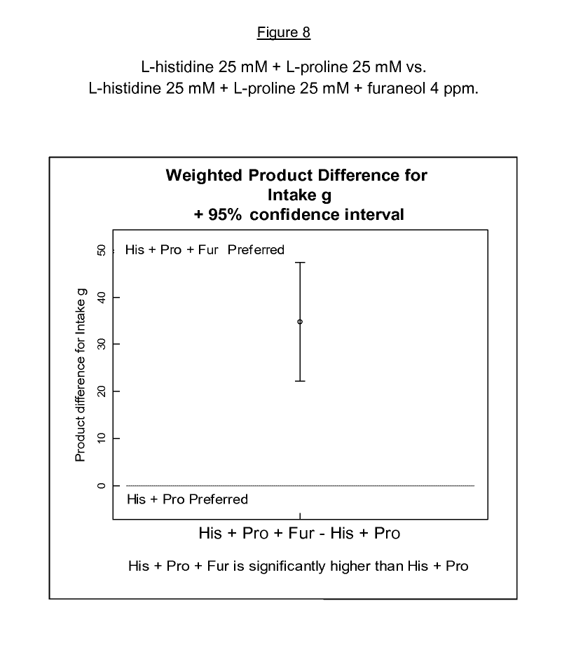

FIG. 7 shows the results in a difference test of a composition comprising 25 mM glycine+25 mM threonine with a composition comprising 50 mM threonine only;

FIG. 8 shows the results of a difference test of a composition comprising 25 mM histidine+25 mM proline+4 ppm furaneol with a composition comprising 25 mM proline+25 mM histidine;

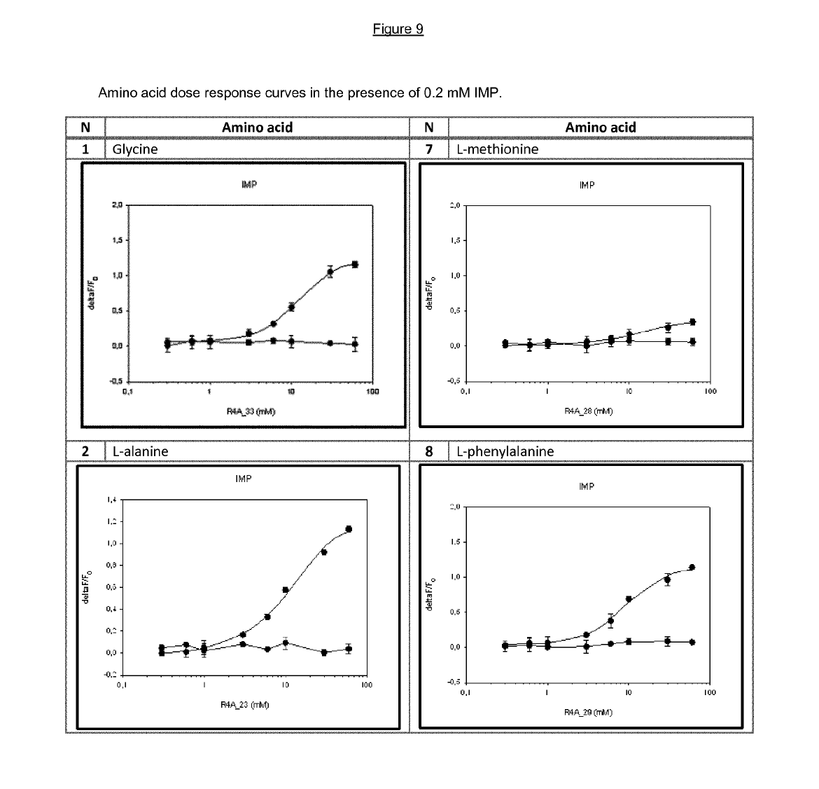

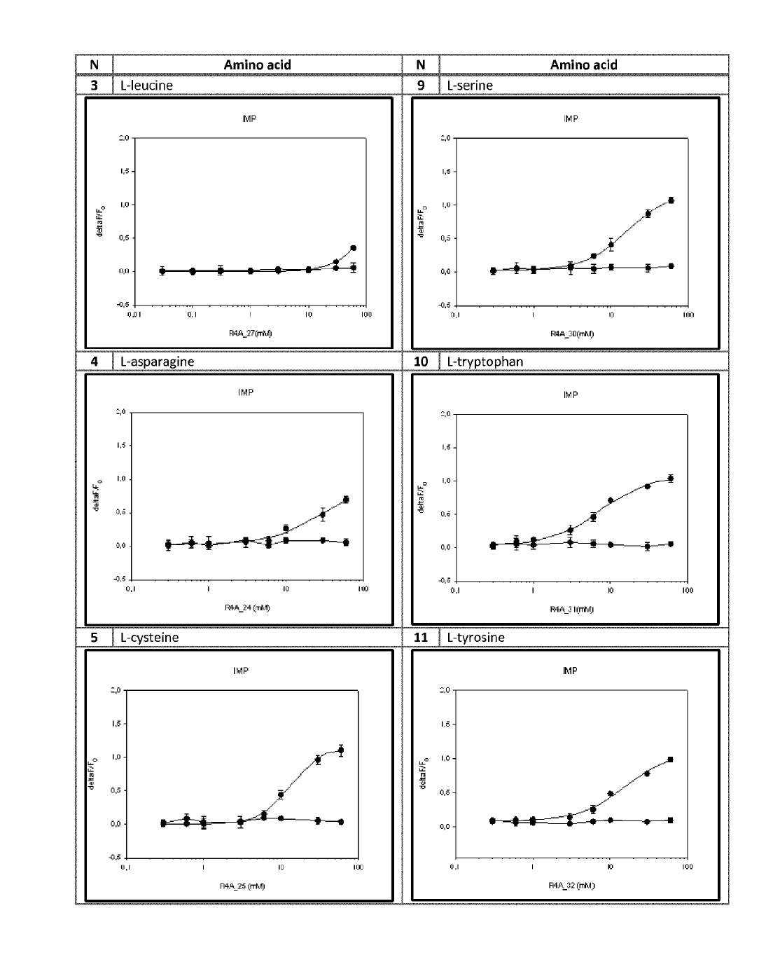

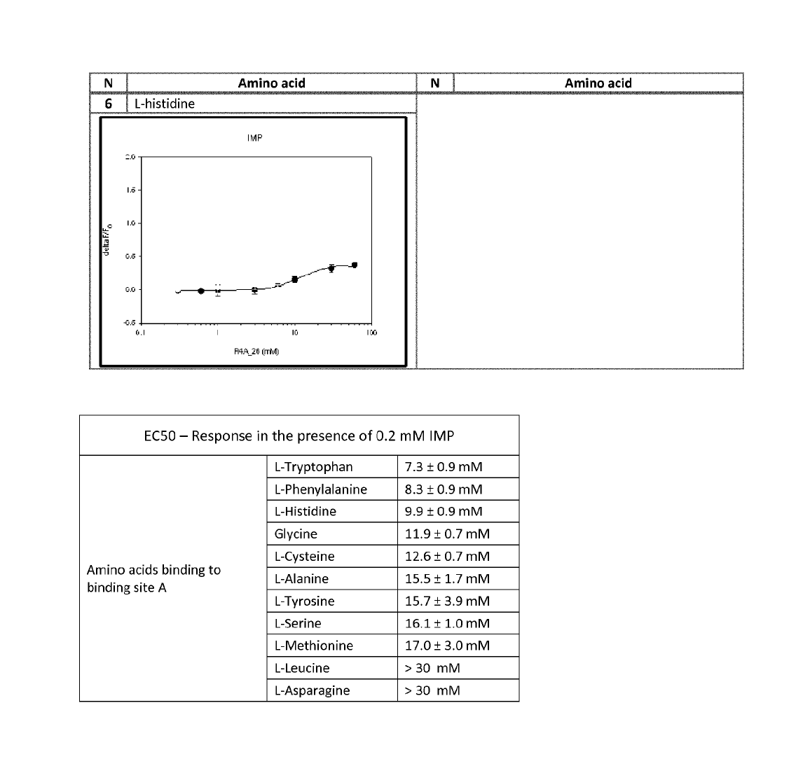

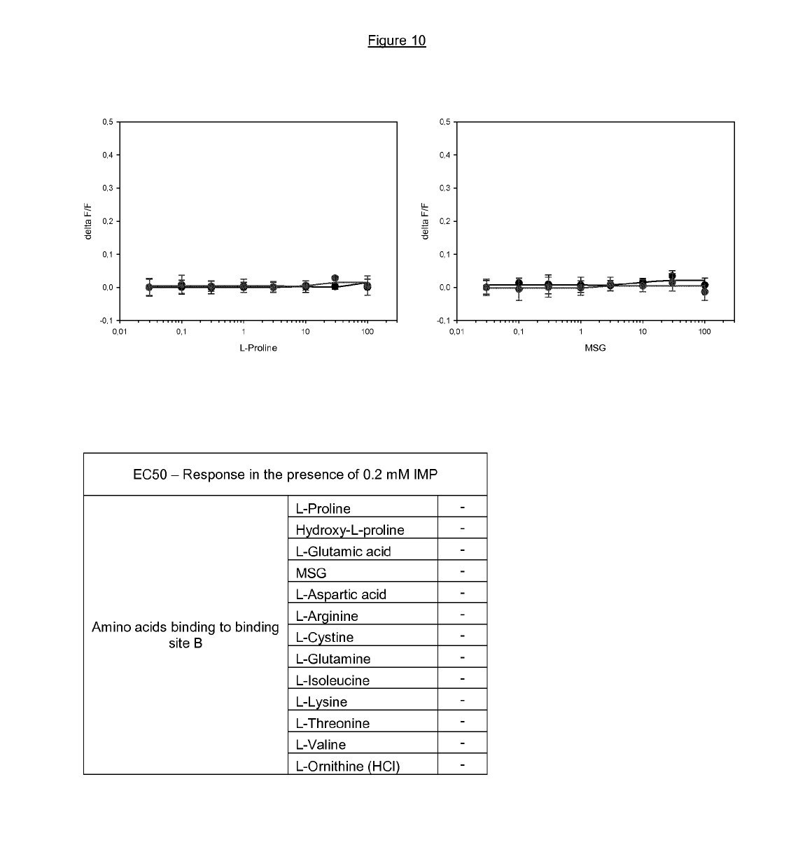

FIG. 9 shows the resulting dose response curves of each first amino acid of the invention that were screened in vitro for their ability to activate the T1R1/T1R3 receptor in the presence of 0.2 mM IMP—the corresponding EC₅₀ values are shown in the table;

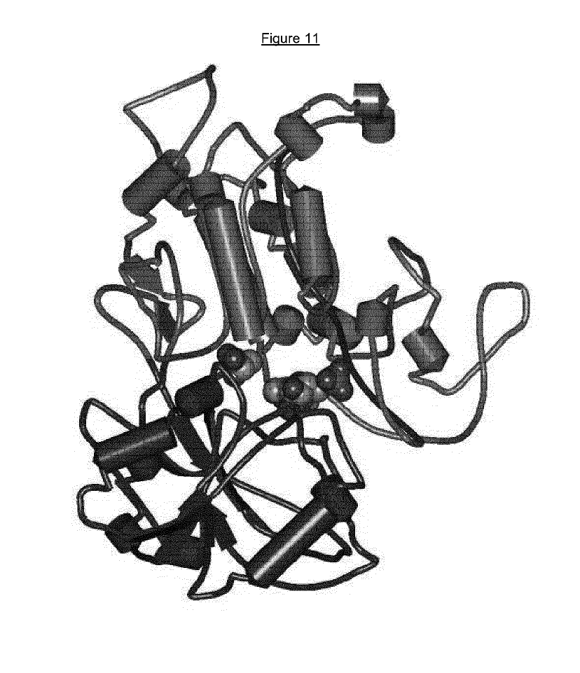

FIG. 10 shows the resulting dose response curves of some second amino acids of the invention that were screened in vitro for their ability to activate the T1R1/T1R3 receptor in the presence of 0.2 mM IMP—the corresponding EC₅₀ values are shown in the table;

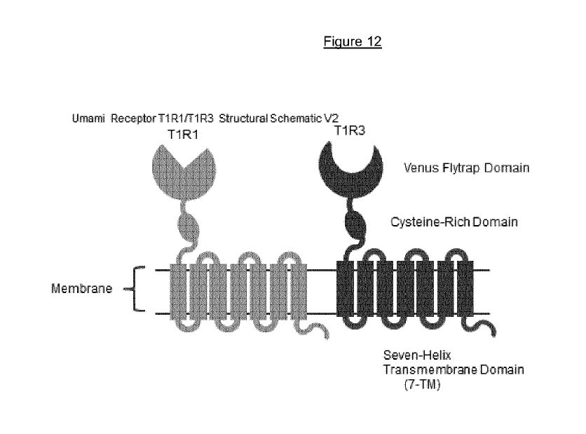

FIG. 11 shows the predicted structure of the T1R1/T1R3 umami receptor;

FIG. 12 shows a schematic of the predicted structure of the umami receptor; and

FIG. 13 shows a sequence alignment of the human, feline and canine umami receptors.

### EXAMPLES

All amino acids of the examples are of the L-form.

### Example 1

Cats were allowed access to water containing either 25 mM proline+25 mM histidine with a composition comprising 50 mM histidine. The methodology used a 2-bottle choice test with 24 cats (the final number of cats for each test can vary due to data being discarded by spillage, etc.). Cats were housed individually during trial periods and had free access to water available between testing periods. The test involved a choice test between the tastant/mixture at a given concentration dissolved in deionised water versus deionised water only or another tastant/mixture. Control was made for positional bias (e.g. A/B exposure 1 and B/A exposure 2) and evaporation loss. The testing time was 36 hours (i.e. 18 hours per day, allowing a two-day crossover). Following two consecutive days of each testing, cats had two consecutive days of rest. Cats were offered a dry diet as a single meal at the start of the test period for one hour, calculated to meet the individual requirements for each cat.

The results are shown in the table below, and in FIG. 1.

### Analysis of Intake g

### ANOVA Table for Fixed Effects

| | Degrees of Freedom | | | |
|---|---|---|---|---|
| Factor | Numerator | Denominator | F-value | P-value |
| Product Difference | 1 | 23 | 15.78 | 0.0006 |

### Table of Mean Product Difference, Standard Error & 95% Confidence Intervals

| Product | | Standard | 95% Confidence Interval | |
|---|---|---|---|---|
| Difference | Mean | Error | Lower | Upper |
| Histidine − His + Pro | −43.60 | 10.98 | −66.30 | −20.89 |

It can be seen that the amount of proline+histidine intake was on average 43.60 g more than histidine alone intake, i.e. the combination of proline and histidine was significantly preferable to the animals over histidine alone.

### Example 2

The difference test was carried out as for Example 1, however, the composition containing 25 mM proline+25 mM histidine was compared with a composition containing 50 mM proline only.

The results are shown below and in FIG. 2.

### Analysis of Intake g

### ANOVA Table for Fixed Effects

| | Degrees of Freedom | | | |
|---|---|---|---|---|
| Factor | Numerator | Denominator | F-value | P-value |
| Product Difference | 1 | 24 | 26.95 | 0.0000* |

*0.0000 indicates a FIGURE of less than 0.0001

### Table of Mean Product Difference, Standard Error & 95% Confidence Intervals

| Product | | Standard | 95% Confidence Interval | |
|---|---|---|---|---|
| Difference | Mean | Error | Lower | Upper |
| Proline − His + Pro | −56.07 | 10.80 | −78.36 | −33.78 |

It can be seen that the amount of proline+histidine intake was on average 56.07 g more than proline alone intake, i.e. the combination of proline and histidine was significantly preferable to the animals over proline alone.

### Example 3

The difference test was carried out as for Example 1, however, a composition containing 25 mM threonine+25 mM histidine was compared with a composition containing 50 mM threonine only.

The results are shown below and in FIG. 3.

### Analysis of Intake g

### ANOVA Table for Fixed Effects

| | Degrees of Freedom | | | |
|---|---|---|---|---|
| Factor | Numerator | Denominator | F-value | P-value |
| Product Difference | 1 | 23 | 34.58 | 0.0000 |

### Table of Mean Product Difference, Standard Error & 95% Confidence Intervals

| Product | | Standard | 95% Confidence Interval | |
|---|---|---|---|---|
| Difference | Mean | Error | Lower | Upper |
| Threonine − His + Thr | −34.48 | 5.86 | −46.61 | −22.35 |

It can be seen that the amount of threonine+histidine intake was on average 34.48 g more than threonine alone intake, i.e. the combination of threonine and histidine was significantly preferable to the animals over threonine alone.

### Example 4

A difference test was carried out as for Example 1, however, a composition containing 25 mM alanine+25 mM threonine was compared with a composition containing 50 mM alanine only.

The results are shown below and in FIG. 4

### ANOVA Table for Fixed Effects

| | Degrees of Freedom | | | |
|---|---|---|---|---|
| Factor | Numerator | Denominator | F-value | P-value |
| Product Difference | 1 | 23 | 0.91 | 0.3499 |

### Table of Mean Product Difference, Standard Error & 95% Confidence Intervals

| Product | | Standard | 95% Confidence Interval | |
|---|---|---|---|---|
| Difference | Mean | Error | Lower | Upper |
| Ala + Thr − 2xAla | 5.17 | 5.41 | −6.03 | 16.36 |

It can be seen that the amount of alanine+threonine intake was on average 5.17 g more than alanine alone intake, i.e. the combination of alanine+threonine was preferable over alanine alone.

### Example 5

A difference test was carried out as for Example 1, however, a composition containing 25 mM threonine+25 mM alanine was compared with a composition containing 50 mM threonine only.

The results are shown below and in FIG. 5

### Analysis of Intake g

### ANOVA Table for Fixed Effects

| | Degrees of Freedom | | | |
|---|---|---|---|---|
| Factor | Numerator | Denominator | F-value | P-value |
| Product Difference | 1 | 23 | 5.30 | 0.0307 |

### Table of Mean Product Difference, Standard Error & 95% Confidence Intervals

| Product | | Standard | 95% Confidence Interval | |
|---|---|---|---|---|
| Difference | Mean | Error | Lower | Upper |
| 2xThr − Ala + Thr | −11.80 | 5.12 | −22.40 | −1.20 |

It can be seen that the amount of threonine+alanine intake was on average 11.80 g more than threonine alone intake, i.e. the combination of threonine and alanine was significantly preferable to the animals over threonine alone.

### Example 6

A difference test was carried out as for Example 1, however, a composition containing 25 mM glycine+25 mM threonine was compared with a composition 50 mM glycine.

The results are shown below and in FIG. 6

### ANOVA Table for Fixed Effects

| | Degrees of Freedom | | | |
|---|---|---|---|---|
| Factor | Numerator | Denominator | F-value | P-value |
| Product Difference | 1 | 23 | 0.80 | 0.3818 |

### Table of Mean Product Difference, Standard Error & 95% Confidence Intervals

| Product | | Standard | 95% Confidence Interval | |
|---|---|---|---|---|
| Difference | Mean | Error | Lower | Upper |
| Gly + Thr − 2xGly | 5.26 | 5.90 | −6.95 | 17.47 |

It can be seen that the amount of glycine+threonine intake was on average 5.26 g more than glycine intake, i.e. the combination of threonine and glycine was preferable to the animals over glycine alone.

### Example 7

A difference test was carried out as for Example 1, however, a composition containing 25 mM threonine+25 mM glycine was compared with a composition containing 50 mM threonine only.

The results are shown below and in FIG. 7

### ANOVA Table for Fixed Effects

| | Degrees of Freedom | | | |
|---|---|---|---|---|
| Factor | Numerator | Denominator | F-value | P-value |
| Product Difference | 1 | 23 | 0.38 | 0.5447 |

### Table of Mean Product Difference, Standard Error & 95% Confidence Intervals

| Product | | Standard | 95% Confidence Interval | |
|---|---|---|---|---|
| Difference | Mean | Error | Lower | Upper |
| Gly + Thr − 2xThr | 2.46 | 4.00 | −5.81 | 10.72 |

It can be seen that the amount of threonine+glycine intake was on average 2.46 g more than threonine alone intake, i.e. the combination of threonine and glycine was preferable to the animals over threonine alone.

### Example 8

A difference test was carried out as for Example 1, however, a composition containing 25 mM histidine+25 mM proline+4 ppm furaneol was compared with a composition containing 25 mM proline+25 mM histidine.

The results are shown below and in FIG. 8

### ANOVA Table for Fixed Effects

| | Degrees of Freedom | | | |
|---|---|---|---|---|
| Factor | Numerator | Denominator | F-value | P-value |
| Product Difference | 1 | 24 | 32.43 | 0.0000 |

### Table of Mean Product Difference, Standard Error & 95% Confidence Intervals

| Product | | Standard | 95% Confidence Interval | |
|---|---|---|---|---|
| Difference | Mean | Error | Lower | Upper |
| His + Pro + Fur − His + Pro | 34.84 | 6.12 | 22.21 | 47.47 |

It can be seen that the amount of histidine+proline+furaneol intake was on average 34.84 g more than proline+histidine intake, i.e. the combination of histidine+proline+furaneol was significantly preferable to the animals over proline+histidine alone.

### Example 9

In vitro screening was carried out in order to establish which first amino acids bind and activate the umami receptor. Results are shown in FIG. 9.

### Example 10

In vitro screening was carried out in order to establish which second amino acids bind and activate the umami receptor. Results are shown in FIG. 10.

1. Use of a first amino acid selected from the group consisting of glycine, alanine, cysteine, histidine, leucine, methionine, phenylalanine, serine, tryptophan, tyrosine and a mixture of two or more thereof; a second amino acid selected from the group consisting of aspartic acid, cystine, glutamic acid, glutamine, isoleucine, lysine, aspartic acid, ornithine, threonine, valine, proline, hydroxyproline and a mixture of two or more thereof; and one or more furanones for increasing the palatability of a foodstuff to a companion animal.

2. The use according to claim 1, wherein the one or more furanones are a compound according to formula I or formula II 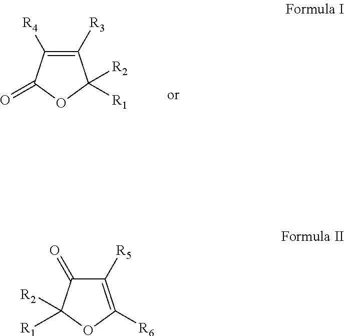
wherein R₁ and R₂ are independently selected from hydrogen, C₁₋₆ alkyl, methyl or ethyl;
R₃ is hydrogen, hydroxyl, C₁₋₆ alkyl or methyl;
R₄ is hydrogen, hydroxyl or C₁₋₆ alkyl;
R₅ is hydrogen, hydroxyl, C₁₋₆ alkyl, C₁₋₆ alkoxy, 5 or 6 membered saturated heterocycle, —OC(O)R₇, —OCH₃, —OCH₂CH₃, —OC(O)CH₃, methyl or pyrrolidine;
R₆ is hydrogen, C₁₋₆ alkyl or methyl;
R₇ is C₁₋₆ alkyl or methyl.

3. The use according to claim 1, wherein the one or more furanones are selected from the group consisting of furaneol, homofuraneol, sotolon, norfuraneol, abhexon, mesifuranone or dimethoxyfuranone, as defined in Table 1.

4. The use according to claim 1, wherein the first amino acid, the second amino acid and the furanone are in addition to any amino acids and furanones that may be found in any meat, vegetable or dairy component of the foodstuff.

5. The use according to claim 1, wherein the total amount of amino acids present is less than 1M.

6. The use according to claim 1, wherein the one or more furanones are present at an amount of less than 40 ppm.

7. A first amino acid selected from the group consisting of glycine, alanine, cysteine, histidine, leucine, methionine, phenylalanine, serine, tryptophan, tyrosine and a mixture of two or more thereof; a second amino acid selected from the group consisting of aspartic acid, cystine, glutamic acid, glutamine, isoleucine, lysine, aspartic acid, ornithine, threonine, valine, proline, hydroxyproline and a mixture of two or more thereof; and one or more furanones for use in increasing the acceptance of a pet foodstuff in a companion animal.

8. A first amino acid, a second amino acid and a furanone for use according to claim 7, wherein the acceptance is a preference for a foodstuff comprising the first amino acid, the second amino acid and the furanone over a foodstuff that does not comprise a first amino acid, a second amino acid and a furanone.

9. A pet foodstuff comprising a first amino acid selected from the group consisting of glycine, alanine, cysteine, histidine, leucine, methionine, phenylalanine, serine, tryptophan, tyrosine and a mixture of two or more thereof; a second amino acid selected from the group consisting of aspartic acid, cystine, glutamic acid, glutamine, isoleucine, lysine, aspartic acid, ornithine, threonine, valine, proline, hydroxyproline and a mixture of two or more thereof, and one or more furanones.

10. A pet foodstuff according to claim 9, wherein the first amino acid, the second amino acid and the furanone are in a combination selected from the group consisting of:
Histidine, proline and Furaneol;
Proline, alanine and Furaneol;
Glycine, threonine and Furaneol;
Alanine, threonine and Furaneol;
Threonine, histidine and Furaneol;
Glutamic Acid, histidine and Furaneol;
Histidine, proline and Sotolon;
Proline, alanine and Sotolon;
Glycine, threonine and Sotolon;
Alanine, threonine and Sotolon;
Threonine, histidine and Sotolon; and
Glutamic Acid, histidine and Sotolon.

11. A method for increasing acceptance of a foodstuff in a companion animal comprising allowing the animal access to a pet food comprising a first amino acid selected from the group consisting of glycine, alanine, cysteine, histidine, leucine, methionine, phenylalanine, serine, tryptophan, tyrosine and a mixture of two or more thereof; a second amino acid selected from the group consisting of aspartic acid, cystine, glutamic acid, glutamine, isoleucine, lysine, aspartic acid, ornithine, threonine, valine, proline, hydroxyproline and a mixture of two or more thereof; and one or more furanones.

12. A process of preparing a pet foodstuff comprising a first amino acid selected from the group consisting of glycine, alanine, cysteine, histidine, leucine, methionine, phenylalanine, serine, tryptophan, tyrosine and a mixture of two or more thereof; a second amino acid selected from the group consisting of aspartic acid, cystine, glutamic acid, glutamine, isoleucine, lysine, aspartic acid, ornithine, threonine, valine, proline, hydroxyproline and a mixture of two or more thereof, and one or more furanones, the process comprising the steps of adding and mixing at least one first amino acid at least one second amino acid and one or more furanones with a pet foodstuff.

13. A process of preparing a pet foodstuff according to claim 12, wherein the process comprises combining one or more pet food ingredient; the first amino acid; the second amino acid; and one or more furanones, wherein the first amino acid, the second amino acid and one or more furanones are added together or separately, and wherein the amino acids and the furanones together provide no more than 30 wt % of the dry matter that is contained in the foodstuff.

14. A process according to claim 13, wherein the one or more pet food ingredients include one or more of the edible materials selected from meat, animal fat, blood plasma, marrowbone, vegetable protein, vegetable fat, milk protein, grains and starch, wherein the one or more edible ingredients provide at least 60 wt % of the dry matter that is contained in the pet foodstuff.

15. A method for increasing the palatability of a foodstuff, the method comprising adding to a foodstuff during or after manufacture a first amino acid selected from the group consisting of glycine, alanine, cysteine, histidine, leucine, methionine, phenylalanine, serine, tryptophan, tyrosine and a mixture of two or more thereof; a second amino acid selected from the group consisting of aspartic acid, cystine, glutamic acid, glutamine, isoleucine, lysine, aspartic acid, ornithine, threonine, valine, proline, hydroxyproline and a mixture of two or more thereof, and one or more furanones.

16. A pet foodstuff produced by the method of claim 12.
